(19) United States
(12) Patent Application Publication
(10) Pub. No.: US 2021/0066721 A1
(43) Pub. Date: Mar. 4, 2021

(54) POLY(3-HEXYLTHIOPHENE-2,5-DIYL) AS A PROTECTIVE COATING FOR HIGH RATE CATHODE MATERIALS

(71) Applicant: THE REGENTS OF THE UNIVERSITY OF CALIFORNIA, Oakland, CA (US)

(72) Inventors: Bruce S. Dunn, Los Angeles, CA (US); Sarah H. Tolbert, Encino, CA (US); Chun-Han Lai, Los Angeles, CA (US); David S. Ashby, Los Angeles, CA (US); Terri C. Lin, Fremont, CA (US); Jonathan Lau, Los Angeles, CA (US); Andrew Dawson, Chino Hills, CA (US)

(73) Assignee: THE REGENTS OF THE UNIVERSITY OF CALIFORNIA, Oakland, CA (US)

(21) Appl. No.: 17/018,002

(22) Filed: Sep. 11, 2020

Related U.S. Application Data
(63) Continuation of application No. PCT/US2019/022085, filed on Mar. 13, 2019.
(60) Provisional application No. 62/642,189, filed on Mar. 13, 2018.

(51) Int. Cl. H01M 4/62; H01M 4/525; H01M 4/36; H01M 10/0525; H01B 1/24

(52) U.S. Cl. CPC H01M 4/622; H01M 4/625; H01M 4/525; H01M 2004/028; H01M 10/0525; H01M 4/628; H01B 1/24; H01M 4/366

(57) ABSTRACT

By mixing Poly (3-hexylthiophene-2,5-diyl) (P3HT) with carbon nanotubes (CNT), the resultant mixture of P3HT-CNT serves as a surface coating for the cathode material LiNi_{0.8}Co_{0.15}Al_{0.05}O₂ (NCA) and offers a number of advantageous properties when used as a conductive binder for lithium-ion battery cathode materials.

### CROSS-REFERENCE TO RELATED APPLICATIONS

This application claims priority to, and is a 35 U.S.C. § 111(a) continuation of, PCT international application number PCT/US2019/022085 filed on Mar. 13, 2019, incorporated herein by reference in its entirety, which claims priority to, and the benefit of, U.S. provisional patent application Ser. No. 62/642,189 filed on Mar. 13, 2018, incorporated herein by reference in its entirety. Priority is claimed to each of the foregoing applications.

The above-referenced PCT international application was published as PCT International Publication No. WO 2019/178252 A1 on Sep. 19, 2019, which publication is incorporated herein by reference in its entirety.

### STATEMENT REGARDING FEDERALLY SPONSORED RESEARCH OR DEVELOPMENT

This invention was made with government support under Grant Number N00014-16-1-2164, awarded by the U.S. Navy, Office of Naval Research, and Grant Number DE-SC0014213, awarded by the U.S. Department of Energy. The government has certain rights in the invention.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to cathode materials for batteries, and more particularly to lithium-ion battery cathode materials.

### 2. Background Discussion

The following publications, which are incorporated herein by reference in their entireties, provide background to the presented technology.

(1) Larcher, D.; Tarascon, J.-M. Towards Greener and More Sustainable Batteries for Electrical Energy Storage. Nat. Chem. 2014, 7 (1), 19-29.

(2) Yang, Z.; Zhang, J.; Kintner-Meyer, M. C. W.; Lu, X.; Choi, D.; Lemmon, J. P.; Liu, J. Electrochemical Energy Storage for Green Grid. Chem. Rev. 2011, 111 (5), 3577-3613.

(3) Denholm, P.; Ela E.; Kirby B.; Milligan M. The Role of Energy Storage with Renewable Electricity Generation. 2010, 1-61.

(4) Lindley, D. Smart Grids: The Energy Storage Problem. Nature 2010, 463 (7277), 18-20.

(5) Dunn, B.; Kamath, H.; Tarascon, J.-M. Electrical Energy Storage for the Grid: A Battery of Choices. Science 2011, 334 (6058), 928-935.

(6) Salanne, M.; Rotenberg, B.; Naoi, K.; Kaneko, K.; Taberna, P.-L.; Grey, C. P.; Dunn, B.; Simon, P. Efficient Storage Mechanisms for Building Better Supercapacitors. Nat. Energy 2016, 1 (6), 16070.

(7) Thackeray, M. M.; Wolverton, C.; Isaacs, E. D. Electrical Energy Storage for Transportation—approaching the Limits of, and Going beyond, Lithium-Ion Batteries. Energ Environ. Sci. 2012, 5 (7), 7854.

(8) Kim, S.-W.; Seo, D.-H.; Ma, X.; Ceder, G.; Kang, K. Electrode Materials for Rechargeable Sodium-Ion Batteries: Potential Alternatives to Current Lithium-Ion Batteries. Adv. Energy Mater. 2012, 2 (7), 710-721.

(9) Kalluri, S.; Yoon, M.; Jo, M.; Park, S.; Myeong, S.; Kim, J.; Dou, S. X.; Guo, Z.; Cho, J. Surface Engineering Strategies of Layered LiCoO₂ Cathode Material to Realize High-Energy and High-Voltage Li-Ion Cells. Adv. Energy Mater. 2017, 7 (1), 1601507.

(10) Vetter, J.; Novak, P.; Wagner, M. R.; Veit, C.; Möller, K.-C.; Besenhard, J. O.; Winter, M.; Wohlfahrt-Mehrens, M.; Vogler, C.; Hammouche, A. Ageing Mechanisms in Lithium-Ion Batteries. J. Power Sources 2005, 147 (1-2), 269-281.

(11) Guilmard, M. Effects of Aluminum on the Structural and Electrochemical Properties of LiNiO2. J. Power Sources 2003, 115 (2), 305-314.

(12) Andersson, A. M.; Abraham, D. P.; Haasch, R.; MacLaren, S.; Liu, J.; Amine, K. Surface Characterization of Electrodes from High Power Lithium-Ion Batteries. J. Electrochem. Soc. 2002, 149 (10), A1358.

(13) Bak, S.-M.; Nam, K.-W.; Chang, W.; Yu, X.; Hu, E.; Hwang, S.; Stach, E. A.; Kim, K.-B.; Chung, K. Y.; Yang, X.-Q. Correlating Structural Changes and Gas Evolution during the Thermal Decomposition of Charged LiₓNi_{0.8}Co_{0.15}Al_{0.50}O₂ Cathode Materials. Chem. Mater. 2013, 25 (3), 337-351.

(14) Liu, W.; Oh, P.; Liu, X.; Lee, M.-J.; Cho, W.; Chae, S.; Kim, Y.; Cho, J. Nickel-Rich Layered Lithium Transition-Metal Oxide for High-Energy Lithium-Ion Batteries. Angew. Chem. Int. Ed. 2015, 54 (15), 4440-4457.

(15) Makimura, Y.; Sasaki, T.; Nonaka, T.; Nishimura, Y. F.; Uyama, T.; Okuda, C.; Itou, Y.; Takeuchi, Y. Factors Affecting Cycling Life of LiNi_{0.8}Co_{0.15}Al_{0.05}O₂ for Lithium-Ion Batteries. J. Mater. Chem. A 2016, 4 (21), 8350-8358.

(16) Schipper, F.; Erickson, E. M.; Erk, C.; Shin, J.-Y.; Chesneau, F. F.; Aurbach, D. Review—Recent Advances and Remaining Challenges for Lithium Ion Battery Cathodes: I. Nickel-Rich, LiNiₓCo_{y}Mn_{z}O₂. J. Electrochem. Soc. 2017, 164 (1), A6220-A6228.

(17) Wong, D.; Shrestha, B.; Wetz, D. A.; Heinzel, J. M. Impact of High Rate Discharge on the Aging of Lithium Nickel Cobalt Aluminum Oxide Batteries. J. Power Sources 2015, 280, 363-372.

(18) Watanabe, S.; Kinoshita, M.; Hosokawa, T.; Morigaki, K.; Nakura, K. Capacity Fade of LiAl_{y}Ni_{1-x-y}CoₓO₂ Cathode for Lithium-Ion Batteries during Accelerated Calendar and Cycle Life Tests (Surface Analysis of LiAl_{y}Ni_{1-x-y}CoₓO₂ Cathode after Cycle Tests in Restricted Depth of Discharge Ranges). J. Power Sources 2014, 258, 210-217.

(19) Lee, D.-J.; Scrosati, B.; Sun, Y.-K. Ni₃(PO₄)₂-Coated LiNi_{0.8}Co_{0.15}Al_{0.05}O₂ Lithium Battery Electrode with Improved Cycling Performance at 55° C. J. Power Sources 2011, 196 (18), 7742-7746.

(20) Hwang, S.; Chang, W.; Kim, S. M.; Su, D.; Kim, D. H.; Lee, J. Y.; Chung, K. Y.; Stach, E. A. Investigation of Changes in the Surface Structure of LiₓNi_{0.8}Co_{0.15}Al_{0.05}O₂ Cathode Materials Induced by the Initial Charge. Chem. Mater. 2014, 26 (2), 1084-1092.

(21) Liu, H.; Wolf, M.; Karki, K.; Yu, Y.-S.; Stach, E. A.; Cabana, J.; Chapman, K. W.; Chupas, P. J. Intergranular Cracking as a Major Cause of Long-Term Capacity Fading of Layered Cathodes. Nano Lett. 2017, 17 (6), 3452-3457.

(22) Zheng, S.; Huang, R.; Makimura, Y.; Ukyo, Y.; Fisher, C. A. J.; Hirayama, T.; Ikuhara, Y. Microstructural Changes in LiNi_{0.8}Co_{0.15}Al_{0.05}O₂ Positive Electrode Material during the First Cycle. J. Electrochem. Soc. 2011, 158 (4), A357.

(23) Makimura, Y.; Zheng, S.; Ikuhara, Y.; Ukyo, Y. Microstructural Observation of LiNi_{0.8}Co_{0.15}Al_{0.05}O₂ after Charge and Discharge by Scanning Transmission Electron Microscopy. J. Electrochem. Soc. 2012, 159 (7), A1070-A1073.

(24) Ceraolo, M.; Lutzemberger, G.; Poli, D. Aging Evaluation of High Power Lithium Cells Subjected to Micro-Cycles. J. Energy Storage 2016, 6, 116-124.

(25) Groenewald, J.; Grandjean, T.; Marco, J. Accelerated Energy Capacity Measurement of Lithium-Ion Cells to Support Future Circular Economy Strategies for Electric Vehicles. Renew. and Sustain. Energy Rev. 2017, 69, 98-111.

(26) Wu, Y.; Keil, P.; Schuster, S. F.; Jossen, A. Impact of Temperature and Discharge Rate on the Aging of a LiCoO₂/LiNi_{0.8}Co_{0.15}Al_{0.05}O₂ Lithium-Ion Pouch Cell. J. Electrochem. Soc. 2017, 164 (7), A1438-A1445.

(27) Ryu, K. S.; Lee, S. H.; Koo, B. K.; Lee, J. W.; Kim, K. M.; Park, Y. J. Effects of Co₃(PO₄)₂ Coatings on LiNi_{0.8}Co_{0.16}Al_{0.40}O₂ Cathodes during Application of High Current. J. Appl. Electrochem. 2008, 38 (10), 1385-1390.

(28) Edström, K.; Gustafsson, T.; Thomas, J. O. The Cathode-electrolyte Interface in the Li-Ion Battery. Electrochimica Acta 2004, 50 (2-3), 397-403.

(29) Lee, S. M.; Oh, S. H.; Ahn, J. P.; Cho, W. I.; Jang, H. Electrochemical Properties of ZrO₂-Coated LiNi_{0.8}Co_{0.2}O₂ Cathode Materials. J. Power Sources 2006, 159 (2), 1334-1339.

(30) Chen, Y.; Zhang, Y.; Chen, B.; Wang, Z.; Lu, C. An Approach to Application for LiNi_{0.6}Co_{0.2}Mn_{0.2}O₂ Cathode Material at High Cutoff Voltage by TiO₂ Coating. J. Power Sources 2014, 256, 20-27.

(31) Du, K.; Xie, H.; Hu, G.; Peng, Z.; Cao, Y.; Yu, F. Enhancing the Thermal and Upper Voltage Performance of Ni-Rich Cathode Material by a Homogeneous and Facile Coating Method: Spray-Drying Coating with Nano-Al₂O₃. ACS App. Mater. Interfaces 2016, 8 (27), 17713-17720.

(32) Woo, S.-U.; Yoon, C. S.; Amine, K.; Belharouak, I.; Sun, Y.-K. Significant Improvement of Electrochemical Performance of AlF₃-Coated LiNi_{0.8}Co_{0.1}Mn_{0.1}O₂ Cathode Materials. J. Electrochem. Soc. 2007, 154 (11), A1005.

(33) Xie, J.; Sendek, A. D.; Cubuk, E. D.; Zhang, X.; Lu, Z.; Gong, Y.; Wu, T.; Shi, F.; Liu, W.; Reed, E. J.; Cui, Y. Atomic Layer Deposition of Stable LiAlF₄ Lithium Ion Conductive Interfacial Layer for Stable Cathode Cycling. ACS Nano 2017, 11 (7), 7019-7027.

(34) Ma, X.; Wang, C.; Han, X.; Sun, J. Effect of AlPO₄ Coating on the Electrochemical Properties of LiNi_{0.8}Co_{0.2}O₂ Cathode Material. J. Alloys Compd. 2008, 453 (1-2), 352-355.

(35) Xia, S.; Li, F.; Chen, F.; Guo, H. Preparation of FePO₄ by Liquid-Phase Method and Modification on the Surface of LiNi_{0.8}Co_{0.15}Al_{0.15}O₂ Cathode Material. J. Alloys Compd. 2018, 731, 428-436.

(36) Novák, P.; Willer, K.; Santhanam, K. S. V.; Haas, O. Electrochemically Active Polymers for Rechargeable Batteries. Chem. Rev. 1997, 97 (1), 207-282.

(37) Cho, S. I.; Lee, S. B. Fast Electrochemistry of Conductive Polymer Nanotubes: Synthesis, Mechanism, and Application. Acc. Chem. Res. 2008, 41 (6), 699-707.

(38) Jurewicz, K.; Delpeux, S.; Bertagna, V.; Béguin, F.; Frackowiak, E. Supercapacitors from Nanotubes/Polypyrrole Composites. Chem. Phys. Lett. 2001, 347 (1-3), 36-40.

(39) Hughes, M.; Chen, G. Z.; Shaffer, M. S. P.; Fray, D. J.; Windle, A. H. Electrochemical Capacitance of a Nanoporous Composite of Carbon Nanotubes and Polypyrrole. Chem. Mater. 2002, 14 (4), 1610-1613.

(40) Kaufman, J. H. Poly(Thiophene): A Stable Polymer Cathode Material. J. Electrochem. Soc. 1984, 131 (9), 2092.

(41) Harada, H.; Fuchigami, T.; Nonaka, T. Degradation and Its Prevention, and the Deactivation and Reactivation of Electroactive Polythiophene Films during Oxidation/Reduction Cycles. J. Electroanal. Chem. Interfacial Electrochem. 1991, 303 (1-2), 139-150.

(42) Bounioux, C.; Díaz-Chao, P.; Campoy-Quiles, M.; Martín-González, M. S.; Goñi, A. R.; Yerushalmi-Rozen, R.; Müller, C. Thermoelectric Composites of Poly(3-Hexylthiophene) and Carbon Nanotubes with a Large Power Factor. Energy Environ. Sci. 2013, 6 (3), 918.

(43) Shi, Y.; Zhou, X.; Yu, G. Material and Structural Design of Novel Binder Systems for High-Energy, High-Power Lithium-Ion Batteries. Acc. Chem. Res. 2017, 50 (11), 2642-2652.

(44) Shi, Y.; Zhou, X.; Zhang, J.; Bruck, A. M.; Bond, A. C.; Marschilok, A. C.; Takeuchi, K. J.; Takeuchi, E. S.; Yu, G. Nanostructured Conductive Polymer Gels as a General Framework Material To Improve Electrochemical Performance of Cathode Materials in Li-Ion Batteries. Nano Lett. 2017, 17 (3), 1906-1914.

(45) Shi, Y.; Peng, L.; Ding, Y.; Zhao, Y.; Yu, G. Nanostructured Conductive Polymers for Advanced Energy Storage. Chem. Soc. Rev. 2015, 44 (19), 6684-6696.

(46) Ju, S. H.; Kang, I.-S.; Lee, Y.-S.; Shin, W.-K.; Kim, S.; Shin, K.; Kim, D.-W. Improvement of the Cycling Performance of LiNi_{0.6}Co_{0.2}Mn_{0.2}O₂ Cathode Active Materials by a Dual-Conductive Polymer Coating. ACS Appl. Mater. Interfaces 2014, 6 (4), 2546-2552.

(47) Lee, J.; Choi, W. Surface Modification of Over-Lithiated Layered Oxides with PEDOT:PSS Conducting Polymer in Lithium-Ion Batteries. J. Electrochem. Soc. 2015, 162 (4), A743-A748.

(48) Kim, J.-M.; Park, H.-S.; Park, J.-H.; Kim, T.-H.; Song, H.-K.; Lee, S.-Y. Conducting Polymer-Skinned Electroactive Materials of Lithium-Ion Batteries: Ready for Monocomponent Electrodes without Additional Binders and Conductive Agents. ACS Appl. Mater. Interfaces 2014, 6 (15), 12789-12797.

(49) Park, K.-S.; Schougaard, S. B.; Goodenough, J. B. Conducting-Polymer/Iron-Redox-Couple Composite Cathodes for Lithium Secondary Batteries. Adv. Mater. 2007, 19 (6), 848-851.

(50) Fedorková, A.; Oriňáková, R.; Oriňák, A.; Talian, I.; Heile, A.; Wiemhöfer, H.-D.; Kaniansky, D.; Arlinghaus, H. F. PPy Doped PEG Conducting Polymer Films Synthesized on LiFePO₄ Particles. J. Power Sources 2010, 195 (12), 3907-3912.

(51) Hotta, S.; Rughooputh, S. D. D. V.; Heeger, A. J.; Wudl, F. Spectroscopic Studies of Soluble Poly(3-Alkylthienylenes). Macromolecules 1987, 20 (1), 212-215.

(52) Rughooputh, S. D. D. V.; Nowak, M.; Hotta, S.; Heeger, A. J.; Wudl, F. Soluble Conducting Polymers: The Poly(3-Alkylthienylenes). Synth. Met. 1987, 21 (1-3), 41-50.

(53) Treat, N. D.; Varotto, A.; Takacs, C. J.; Batara, N.; Al-Hashimi, M.; Heeney, M. J.; Heeger, A. J.; Wudl, F.; Hawker, C. J.; Chabinyc, M. L. Polymer-Fullerene Miscibility: A Metric for Screening New Materials for High-Performance Organic Solar Cells. J. Am. Chem. Soc. 2012, 134 (38), 15869-15879.

(54) Wu, S.-L.; Javier, A. E.; Devaux, D.; Balsara, N. P.; Srinivasan, V. Discharge Characteristics of Lithium Battery Electrodes with a Semiconducting Polymer Studied by Continuum Modeling and Experiment. J. Electrochem. Soc. 2014, 161 (12), A1836-A1843.

(55) Thelen, J. L.; Wu, S.-L.; Javier, A. E.; Srinivasan, V.; Balsara, N. P.; Patel, S. N. Relationship between Mobility and Lattice Strain in Electrochemically Doped Poly(3-Hexylthiophene). ACS Macro Lett. 2015, 4 (12), 1386-1391.

(56) Patel, S. N.; Javier, A. E.; Balsara, N. P. Electrochemically Oxidized Electronic and Ionic Conducting Nanostructured Block Copolymers for Lithium Battery Electrodes. ACS Nano 2013, 7 (7), 6056-6068.

(57) Carmona, F.; El Amarti, A. Anisotropic Electrical Conductivity in Heterogeneous Solids with Cylindrical Conducting Inclusions. Phys. Rev. B 1987, 35 (7), 3284-3290.

(58) Alexander, M.; Romberg, H.; Nücker, N.; Adelmann, P.; Fink, J.; Markert, J. T.; Maple, M. B.; Uchida, S.; Takagi, H.; Tokura, Y.; James, A. C. W. P.; Murphy, D. W. Electronic Structure Studies on the n -Type Doped Superconductors R₂₋ₓMₓCuO_{4-δ} (R=Pr,Nd,Sm; M=Ce,Th) and Nd₂CuO₄₋ₓFₓ by Electron-Energy-Loss Spectroscopy. Phys. Rev. B 1991, 43 (1), 333-343.

(59) Musumeci, A. W.; Silva, G. G.; Liu, J.-W.; Martens, W. N.; Waclawik, E. R. Structure and Conductivity of Multi-Walled Carbon Nanotube/Poly(3-Hexylthiophene) Composite Films. Polymer 2007, 48 (6), 1667-1678.

(60) Verploegen, E.; Mondal, R.; Bettinger, C. J.; Sok, S.; Toney, M. F.; Bao, Z. Effects of Thermal Annealing Upon the Morphology of Polymer-Fullerene Fullerene Blends. Adv. Funct. Mater. 2010, 20 (20), 3519-3529.

(61) Scholes, D. T.; Yee, P. Y.; Lindemuth, J. R.; Kang, H.; Onorato, J.; Ghosh, R.; Luscombe, C. K.; Spano, F. C.; Tolbert, S. H.; Schwartz, B. J. The Effects of Crystallinity on Charge Transport and the Structure of Sequentially Processed F4TCNQ-Doped Conjugated Polymer Films. Adv. Funct. Mater. 2017, 27 (44), 1702654.

(62) Enengl, C.; Enengl, S.; Pluczyk, S.; Havlicek, M.; Lapkowski, M.; Neugebauer, H.; Ehrenfreund, E. Doping-Induced Absorption Bands in P3HT: Polarons and Bipolarons. ChemPhysChem 2016, 17 (23), 3836-3844.

(63) LindstrOm, H.; Södergren, S.; Solbrand, A.; Rensmo, H.; Hjelm, J.; Hagfeldt, A.; Lindquist, S.-E. Li +Ion Insertion in TiO₂ (Anatase). 2. Voltammetry on Nanoporous Films. J. Phys. Chem. B 1997, 101 (39), 7717-7722.

(64) Yu, W.; Zhou, J.; Bragg, A. E. Exciton Conformational Dynamics of Poly(3-Hexylthiophene) (P3HT) in Solution from Time-Resolved Resonant-Raman Spectroscopy. J. Phys. Chem. Lett. 2012, 3 (10), 1321-1328.

(65) Lei, J.; McLarnon, F.; Kostecki, R. In Situ Raman Microscopy of Individual LiNi_{hd 0.8}Co_{0.15}Al_{0.05}O₂ Particles in a Li-Ion Battery Composite Cathode. J. Phys. Chem. B 2005, 109 (2), 952-957.

(66) Robert, R.; Bünzli, C.; Berg, E. J.; Novák, P. Activation Mechanism of LiNi_{0.08}Co_{0.15}Al_{0.5}O₂: Surface and Bulk Operando Electrochemical, Differential Electrochemical Mass Spectrometry, and X-Ray Diffraction Analyses. Chem. Mater. 2015, 27 (2), 526-536.

(67) Amin, R.; Ravnsbaek, D. B.; Chiang, Y.-M. Characterization of Electronic and Ionic Transport in Li₁₋ₓNi_{0.8}Co_{0.15}Al_{0.5}O₂ (NCA). J. Electrochem. Soc. 2015, 162 (7), A1163-A1169.

(68) Barsoukov, E.; Macdonald, J. R. Impedance Spectroscopy Theory, Experiment, and Applications.; Wiley-Interscience: Hoboken, N.J., 2005.

(69) Zhang, L.; Fu, J.; Zhang, C. Mechanical Composite of LiNi_{0.8}Co_{0.15}Al_{0.05}O₂/Carbon Nanotubes with Enhanced Electrochemical Performance for Lithium-Ion Batteries. Nanoscale Res. Lett. 2017, 12 (1).

(70) Shim, J.-H.; Kim, Y.-M.; Park, M.; Kim, J.; Lee, S. Reduced Graphene Oxide-Wrapped Nickel-Rich Cathode Materials for Lithium Ion Batteries. ACS Appl. Mater. Interfaces 2017, 9 (22), 18720-18729.

### BRIEF SUMMARY

Poly (3-hexylthiophene-2,5-diyl) (P3HT), which is a conducting polymer studied extensively for its optoelectronic devices, offers a number of advantageous properties when used as a conductive binder for lithium-ion battery cathode materials. By mixing with carbon nanotubes (CNT), P3HT-CNT serves as a surface coating for the cathode material LiNi_{0.8}Co_{0.15}Al_{0.05}O₂ (NCA). Oxidation of the P3HT enables high electronic and ionic conductivity to be achieved over the potential range where the NCA is electrochemically active. In addition to the conductivity benefits from electrochemical doping, the P3HT-CNT coating suppresses electrolyte breakdown, thus inhibiting growth of the solid electrolyte interphase (SEI) layer and preventing intergranular cracking in the NCA particles. The use of the P3HT-CNT binder system leads to improved cycling for NCA at high power density with capacities of 80 mAh g⁻¹ obtained after 1000 cycles at 16C, a value that is 4 times greater than what is achieved in the control electrode.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1(a) through 1(d): (a) XRD pattern of P3HT-CNT thin film shows layered polymer-chain structures before and after cycling. (b) Cyclic voltammetry curves for P3HT-CNT thin film using sweep rates from 1 mV s⁻¹ to 50 mV s⁻¹. (c) Log of the peak current vs. log of the sweep rate for the data shown in (b). The slope gives the b-value of Equation 1. (d) b-value as a function of potential between 3.4 V and 4.2 V vs. Li/Li⁺.

FIG. 2(a) through 2(d): (a) SEM image of P3HT-NCA electrode shows the NCA particles uniformly covered by P3HT and CNTs. (b) HRTEM cross-section of the NCA-P3HT surface. The P3HT-CNT coating is ˜15 nm in thickness. (c) Cu-Kα and synchrotron transmission XRD pattern for NCA-P3HT electrodes. Peaks from the Al substrate are marked with asterisks. (d) Raman spectra of the NCA-P3HT electrode surface show the emergence of different peaks as a function of laser exposure time.

FIGS. 3(a) and 3(b): Initial cyclic voltammetry curves for (a) NCA-P3HT and (b) NCA-PVdF electrodes at 0.5 mV s⁻¹. Inset of (a) shows polaron transition peak for P3HT at 3.43V (vs. Li/Li⁺) during the first charging cycle.

FIG. 4(a) through 4(d): CV curves (5^{th} cycle) for (a) NCA-P3HT and (b) NCA-PVdF electrodes as a function of sweep rate, from 0.1 mV s⁻¹ to 0.5 mV s⁻¹. (c) b-value variation as a function of potential for NCA-P3HT and NCA-PVdF electrodes during discharge. (d) Overpotentials of redox peaks as a function of sweep rate for the results shown in (a) and (b) above.

FIG. 5: Ni 2p, P 2p, S 2p, Li 1s, F 1s, and O 1s XPS spectra for the NCA-PVdF (black) and NCA-P3HT (red) electrodes after the CV cycling shown in FIG. 4. For both electrodes, the NCA is in the delithiated state.

FIG. 6(a) through 6(d): Electrochemical properties for NCA-P3HT and NCA-PVdF electrodes: Galvanostatic cycling profiles for (a) NCA-P3HT electrode and (b) NCA-PVdF electrode. (c) Rate capability obtained from the galvanostatic cycling in (a) and (b). (d) Long-term cycling for NCA-P3HT shows good stability at both 1C and 16C. Cycling for NCA-PVdF at 16C is shown for comparison.

FIG. 7(a) aand 7(b): (a) Impedance spectra of NCA-P3HT at the early stages of cycling (Cycle 21) and after long-term cycling (Cycle 1021). The impedance spectrum for NCA-PVdF after long-term cycling (Cycle 1021) is shown for comparison. (b) Equivalent Randles circuit used to fit the impedance spectra in (a) involves three charge-transfer resistances as discussed in the text: R_{ct1} (high-frequency), R_{ct2} (mid-frequency), and R_{ct3} (low-frequency).

FIGS. 8(a) and 8(b): Transmission X-ray microscopy (TXM) images for (a) a cycled NCA electrode and (b) a single NCA particle.

### DETAILED DESCRIPTION

This disclosure describes using PPoly (3-hexylthiophene-2,5-diyl) (P3HT) for both surface protection and as a conductive layer for LiNi_{0.8}Co_{0.15}Al_{0.5}O₂ (NCA) electrodes. The thickness is carefully controlled to limit the ionic resistance while providing sufficient electronic conduction. The improved conduction enables higher power densities to be attained in comparison to the control NCA electrodes which were made with the standard binder polymer, PVdF. The dense P3HT coating provides limited spacing for ion transport of bulky reactants generated from the electrolyte breakdown. In this way, the P3HT functions as an artificial solid-electrolyte interphase (SEI), protecting the NCA from degradation. The integration of P3HT with NCA enables the resulting material to perform as a high rate positive electrode for lithium-ion batteries.

A. Experimental Section.

1. Fabrication of P3HT Thin Film and P3HT-coated NCA Electrodes.

A 15 g L⁻¹ solution of P3HT (electronic grade, MW15000-45000, regioregularity >98%, Sigma-Aldrich) combined with multi-walled carbon nanotubes (O.D.×I.D.×L:10 nm×4.5 nm×3˜6 μm, Sigma-Aldrich) is prepared in 1,2-Dichlorobenzene (ODCB, Sigma-Aldrich) with a weight ratio of 8:2. To prepare a 50-nm thin-film electrode, 50 μl of the solution was spin-coated at 2000 rpm for 60 sec onto a 2 cm×2 cm fluorine doped tin oxide (FTO, 7 Ω/sq, Sigma-Aldrich) coated glass. Electrodes with thickness higher than 50 nm were prepared by drop-casting a diluted 1 g L⁻¹ P3HT/ODCB solution. The concentrations for P3HT solutions were based on their respective coating processes. For the spin coating, a high viscosity 15 g L⁻¹ solution was required to ensure reasonable P3HT film thickness and uniform coating on the FTO substrates. Such solutions are too concentrated for drop casting and much lower concentration solutions (˜1 g L⁻¹) are preferred to allow the solution to spread and cover the entire electrode without making a film that is too thick. We used both methods because the spin coated films have thicknesses similar to those on the surface of our active electrode material, while the drop cast films had drying kinetics more similar to the electrodes. The as-prepared films were vacuum-dried at room temperature for 4 hr and then transferred to a vacuum oven at 110° C. overnight. Before testing, samples were annealed on a hotplate at 140° C. for 5 min and transferred into a glovebox.

2. Materials Characterization.

To prepare NCA electrodes using P3HT binder (NCA-P3HT), a slurry composed of NCA particles (LiNi_{0.8}Co_{0.15}Al_{0.05}O₂, Quallion Corp., Sylmar, CA), carbon nanofibers (CNF, D×L: 100 nm×20˜200 μm, Sigma Aldrich), CNT, and P3HT in a weight ratio of 90:3:4:3 was prepared in ODCB. The slurry for the control electrode (NCA-PVdF) using polyvinylidene fluoride (PVdF, Sigma Aldrich) as binder was also prepared with CNT and CNF at the same ratio in N-Methyl-2-pyrrolidone (NMP, Sigma Aldrich). The purpose of CNF addition is to provide long-range electronic conduction of electrodes. Both slurries were coated onto aluminum foil using doctor blading, followed by drying in the vacuum oven at 110° C. overnight. Before cycling, the NCA-P3HT electrodes were annealed at 140° C. for 5 min. The NCA-coated foil was punched into 1 cm² discs, leading to a mass loading about 1.5 mg cm⁻².

Scanning electron microscopy (SEM; Nova 230 Nano SEM) was used to capture surface morphologies for P3HT thin-film and NCA electrodes. Energy-dispersive X-ray spectroscopy (EDX) was used to identify elemental distribution on P3HT-coated NCA electrodes. High-resolution transmission electron microscopy (HRTEM; FEI Tecnai G2) was used to characterize the P3HT coating on the NCA surfaces. X-ray diffraction (XRD; PANalytical, X'PertPro) using Cu Kα(λ=1.54 Å) and synchrotron XRD (Stanford Synchrotron Radiation Lightsource, SSRL at beam line 11-3 at 12300 eV) were used to quantify the crystallinity of P3HT thin film and NCA particles. The XRD data was collected using a MAR 345 Image Plate with 120 mm work distance from Q=0 to 5.0 Å⁻¹. All diffraction peaks were normalized to the Al peak using Area Diffraction Machine. Raman spectroscopy (Renishaw inVia) collected at 514 nm was used to characterize the P3HT coating on NCA electrodes. X-ray photoelectron spectroscopy (XPS; Kratos Axis Ultra) with a monochromatic aluminum X-ray source was used to determine the SEI compositions of the cycled NCA electrodes. Peak calibration was performed using the adventitious carbon peak.

Absorption images were collected using transmission X-ray microscopy (TXM) at SSRL beam line 6-2 at 8.98 keV. To capture clear images of single particles, the mass loading of these ex-situ electrodes were adjusted to about 0.5 mg/cm² to avoid particle aggregation. The electrodes were charged and discharged at 16 C (2.56 mA g⁻¹) for 450 cycles in a coin cell and transferred to a X-ray transparent Al pouch cell in an Ar glovebox. For the measurement, a 6 by 6 matrix of 34 μm×34 μm images was taken at different regions with 1 second exposure time. Reference correction and global normalization of the X-ray micrographs was done using TXM-Wizard (an in-house developed software package) and the contrast for different images was further adjusted using ImageJ. The reference-corrected images were first converted to 8 bit images that consist of pixels linearly scaled to 255 different grey-levels (0 being white and 255 being black). The contrast of these images was then slightly tuned to improve the contrast between the features of interest. Precautions were taken during this process to maintain all features in the original image.

3. Electrochemical Characterization.

Cyclic voltammetry (CV), galvanostatic charge-discharge (GCD), and electrochemical impedance spectroscopy (EIS) were carried out using a VMP potentiostat/galvanostat (Bio-Logic) at 2.7-4.2 V versus Li. CV curves used in the kinetic studies were collected at their 5^{th} cycle to ensure that the curves were stable. For the GCD testing, different C-rates were used on the basis of 1C=160 mA g⁻¹. EIS was conducted after electrodes were held at selected potential for 2 hr, using an amplitude of 10 mV over the frequency range 300 kHz-1 mHz. The P3HT-CNT films coated on FTO substrates (1 cm×1 cm) were tested in a three-neck flooded cell with two Li foils as counter and reference electrodes using 1M LiPF₆ electrolyte in a 1:1 volume ratio in ethylene carbonate (EC)/dimethyl carbonate (DMC). The NCA-P3HT and NCA-PVdF electrodes were tested in CR2032 coin-type cells with a Li counter electrode and glass fiber separator using the same electrolyte. The specific capacity (mAh/g) was based on the weight of the NCA in the electrode.

B. Results & Discussion

1. Electrochemical Properties of P3HT Thin Film Electrodes.

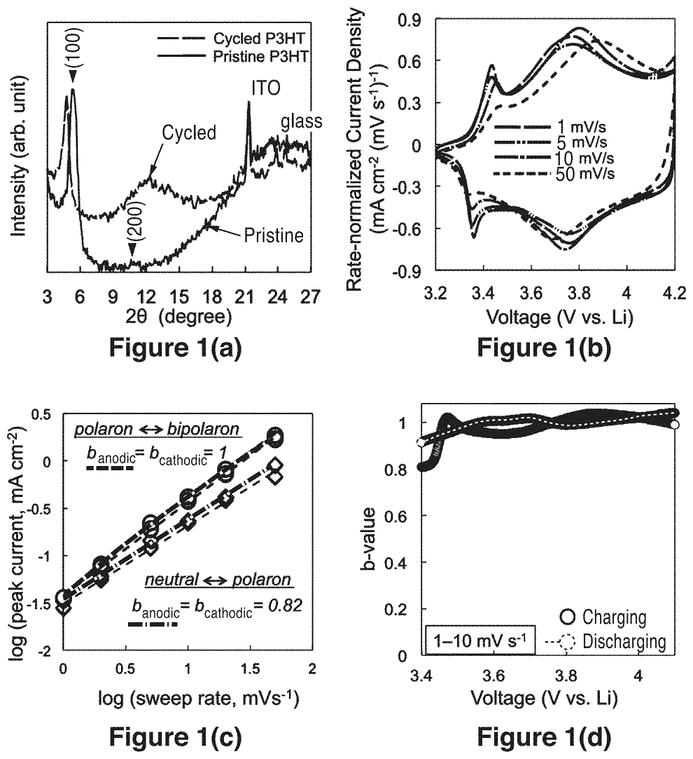

Electrochemical properties of thin-film P3HT were characterized using solutions of P3HT with 20 wt % carbon nanotubes spin coated on FTO-glass. The addition of CNTs creates mesoscale porosity that enables electrolyte to better penetrate the redox-active material.⁵⁷⁻⁵⁹ XRD patterns for the P3HT-CNT thin film in FIG. 1a show the polymer chain arrangement before and after electrochemical cycling. A strong (100) peak at 5.4° and weak (200) peak at 10.7°, corresponding to a lamellar chain-to-chain spacing of 16.5 Å, indicate that the P3HT is crystalline.⁴² The absence of an (010) peak in this θ-θ diffraction scan further confirms that that these P3HT films show the standard edge-on chain orientation.⁶⁰ After cycling, the (100) peak shifts to a lower angle corresponding to a layer spacing of 18.3 Å. Similar shifts have been observed previously in chemically doped P3HT and have been associated with a decrease in the n-stacking distance in the doped system and a corresponding increase in the lamellar spacing.⁶¹ Anion incorporation into the film may also contribute to this shift. A broad peak at 12.2° (7.3 Å) suggests that the electrochemical doping process also creates some more disordered chain conformations.

The thickness of the P3HT-CNT thin film is controlled to be approximately 50 nm to provide better resolution of the electrochemical behavior. Electrochemical doping of P3HT-CNT thin films is demonstrated in FIG. 1b by cyclic voltammetry (CV) between 3 and 4.2 V using varying sweep rates. Two pairs of redox peaks, found at 3.4 V and 3.75 V vs. Li/Li⁺, have been associated with the formation of P3HT polarons and bipolarons, respectively.⁶² The conductivity of doped P3HT has been reported to have values as high as 30-100 S cm^{-1.50,51}The consistent responses seen for thin-film P3HT-CNT cycling with varying sweep rates suggests that the doping/dedoping processes are not kinetically limited in the voltage range studied. The P3HT film has a specific capacity of 34 mAh g⁻¹. The CNTs do not participate in the electrochemical reactions because of the voltage range.

The kinetics of the redox process can be determined by the power-law relationship,⁶³

I=avb (1)

where I is the peak current, v is the sweep rates, and the power, b, indicates whether the redox process is diffusion-controlled (b=0.5) or surface-controlled (b=1). FIG. 1c shows that b values derived from redox peaks at 3.75 V on the CV curves are equal to 1, indicating that charge transfer is not diffusion controlled. The neutral-polaron transition, at 3.4V,⁵⁸ has a b value of 0.82 indicating some diffusion contribution to the kinetics, likely related to the poor electronic conductivity along the undoped chains. The fast kinetics of anion doping in P3HT helps ensure the coating becomes highly conductive at the beginning of NCA charging. FIG. 1d shows b-value variation in the potential range of NCA operation. From 3.5 V to 4.2 V, the b-value is continuously close to 1.

The electrochemical behavior of the P3HT-CNT films provides important insight into the function of the P3HT in relation to the NCA. The ability to carry out redox reactions at high rate (50 mV s⁻¹) demonstrates that the P3HT supports high electronic and ionic conductivity. Moreover, this behavior occurs over the potential range (3.0 to 4.2V vs. Li/Li⁺) where the NCA is electrochemically active. This electrochemical compatibility, in combination with the good electron and ion transport and the ability to impede electrolyte degradation reactions (vide infra) lead to improved high rate charge storage properties for NCA. The importance of keeping the P3HT-CNT films thin is evident when characterizing films with thicknesses ranging between 300 nm and 4 μm. CV curves for a 4-μm thick electrode showed a larger polarization compared to the 50 nm P3HT-CNT films in FIG. 1b. In addition, b-values at both cathodic and anodic CV peak potentials drop rapidly with increased film thickness indicating that the doping process became diffusion-controlled. This kinetic limitation indicates that only thin films of P3HT-CNT should be incorporated to ensure adequate electron conduction and ion transport.

2. Characterization of P3HT-Coated NCA (NCA-P3HT) Electrodes.

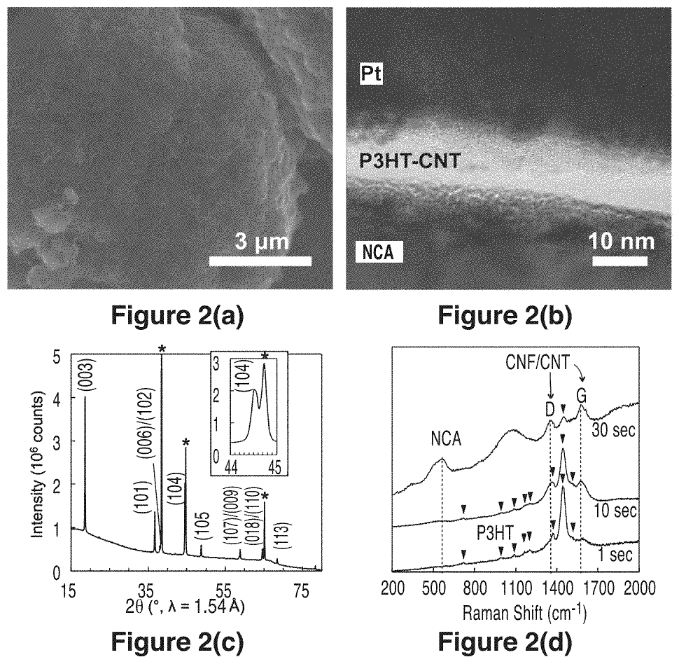

The P3HT-CNT film has been shown to be electronically conductive and permeable to ions when the thickness is in the 50 nm range. In addition, to be truly useful as a conductive coating, the polymer must uniformly cover the NCA. We evaluated the surface morphology of an NCA-P3HT electrode in which the P3HT (3 wt %) and CNT (3 wt %) preferentially coat micron-sized NCA particles. There was some evidence of CNF (4 wt %) which extends through the entire electrode to provide long-range electronic conductivity. EDX elemental mapping showed that the NCA was uniformly covered with the P3HT-CNT coating. Control electrodes, NCA-PVdF, comprised of CNT, CNF, and PVdF binder were also prepared using the same formulation ratio, only replacing P3HT with PVdF. Both electrodes exhibited similar architectures. A magnified image in FIG. 2a shows the surface morphology of a single NCA particle covered with the P3HT-CNT layer. The CNTs are seen distributed evenly on the NCA surface providing short-range electron conduction and, as indicated previously, providing mesoscale porosity to facilitate electrolyte penetration throughout the film. A high-resolution TEM (HRTEM) image in FIG. 2b reveals that the thickness of the P3HT-CNT coating on NCA is around 15 nm.

XRD and Raman spectroscopy enable us to obtain better understanding of the chemical nature of the P3HT-CNT film and the interface with NCA. FIG. 2c shows the synchrotron XRD pattern for the NCA-P3HT electrode. The NCA particles have the α-NaFeO₂ layered structure with a c/a ratio of 1.7. The integrated peak intensity ratio of I₀₀₃/I₁₀₄ is around 1.5, indicating a highly-ordered layered structure with negligible cation-mixing.¹⁵ No change in the XRD pattern was observed upon the addition of P3HT; the 15-nm P3HT coating on the NCA was not thick enough for independent XRD analysis, indicating that the P3HT was homogeneously coating all surfaces in a very thin layer. Instead, Raman spectroscopy using transient laser pulses was used to characterize the surface coating of P3HT-CNT and the NCA particles (FIG. 2d). The spectrum obtained with a single one-second laser exposure shows only peaks of the P3HT coating: 723 cm⁻¹ for C_{α}-S-C_{α}′ deformation, 995 cm⁻¹ for C_{β}-C_{alkyl} stretching, 1092 cm⁻¹ for C_{β}-H bending, 1164 cm⁻¹ and 1201 cm⁻¹ for C_{α}-C_{α}′ stretching, 1381 cm⁻¹ for C_{α}-C_{α}′ stretching, 1451 cm⁻¹ for C_{α}-C_{β} stretching, and a shoulder at 1525 cm⁻¹. This spectrum matches the ground-state pre-resonance of oligomers.⁶⁴ Longer laser exposure times (10 seconds) show the P3HT peaks diminishing, an indication of thermal or optical decomposition of the polymer. At the same time, peaks for the G band (1585 cm⁻¹) from CNF/CNT and D band (1368 cm⁻¹) increase because degradation of the P3HT allows the carbon components in the electrode to be exposed to the laser light. After 30 second exposure, a broad peak appears at 580 cm⁻¹ for the hexagonal phase of pristine NCA.⁶⁵ The Raman and XRD data thus both indicate that P3HT fully covers the NCA.

3. Kinetic Analysis of NCA Electrodes.

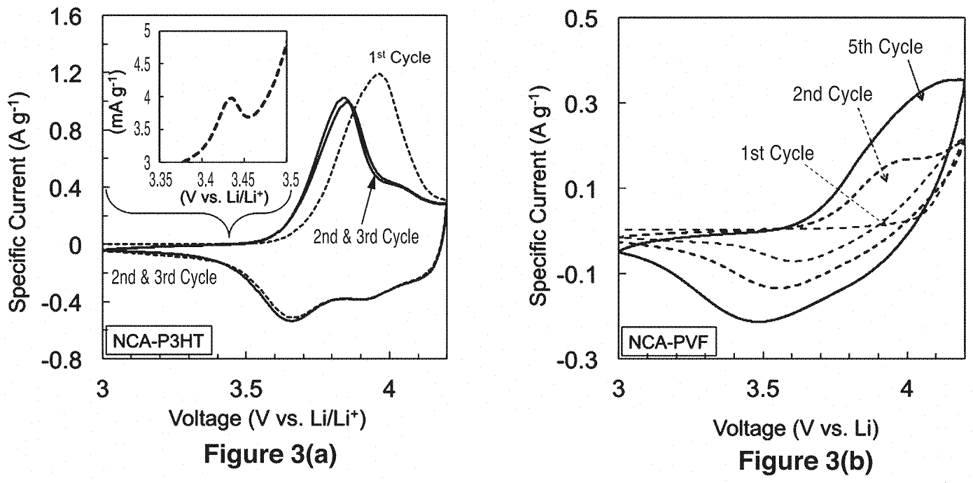

Regardless of the coating, to access reversible Li-ion storage, NCA must first be brought into the rhombohedral phase, as a completely delithiated NCA layered structure is required for reversible intercalation. This phase transition occurs during the first-charge when NCA is cycled in the potential range 3.0-4.2 V. The charging process usually occurs at slow rates to allow complete transformation. FIGS. 3a and 3b show the first CV cycles for NCA-P3HT and NCA-PVdF electrodes, respectively, at a sweep rate of 0.5 mV s⁻¹. After the first charge, the curves of NCA-P3HT overlap with subsequent cycles, indicating that the phase transition is complete and a stable SEI has formed. Redox peaks found at 3.85V and 3.65V for deintercalation and intercalation, respectively, match well to the Ni³⁺/Ni⁴⁺ transition.⁶³ First cycle charge capacity of 187 mAh g⁻¹ and discharge capacity of 160 mAh g⁻¹ were obtained, corresponding to a 0.75 depth of charge with around 15% capacity loss associated with SEI formation and irreversible structural change.¹⁵ It should be noted that only 1 mAh/g is attributed to the 15 nm layer of P3HT-CNT coating. The inset in FIG. 3a shows a peak associated with polaron formation of P3HT at 3.43 V during the first charging cycle, indicating that the doping process was initiated at the beginning of the NCA charging process. In contrast, the control NCA-PVdF electrode has no obvious lithiation/delithiation peaks in the first few cycles due to the large polarization. The CV for this electrode after 5 cycles still showed an incomplete charging peak at 4.2 V, and the discharge capacity after 5 cycles is only 76 mAh g⁻¹, with a single discharge peak at 3.45 V. This behavior shows that the formation process in NCA-PVdF is less favorable compared to NCA-P3HT.

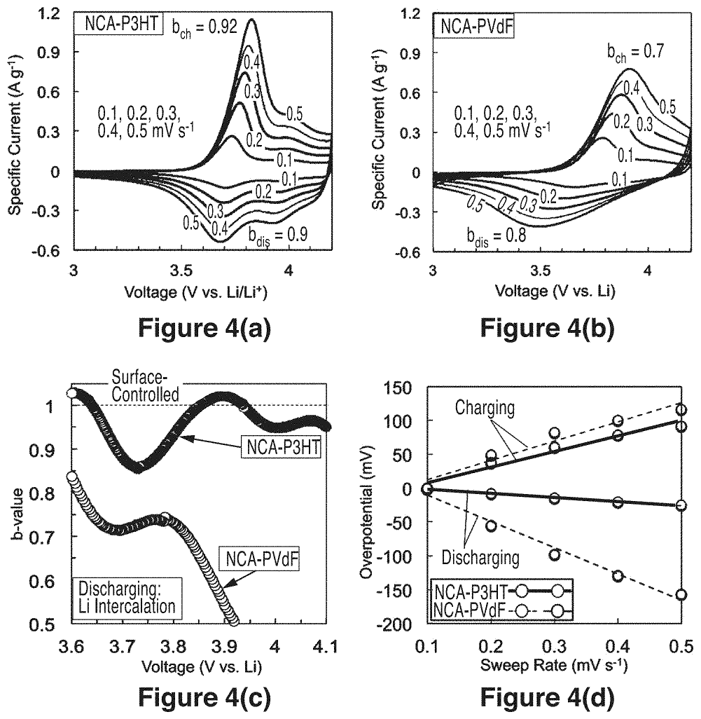

An analysis of the kinetics of the NCA electrodes can be used to explain the improved first cycle charge/discharge process for NCA-P3HT. FIGS. 4a and 4b show CV curves (5^{th} cycle) for different sweep rates for the NCA-P3HT and NCA-PVdF, respectively. At 0.5 mV s⁻¹, the NCA-P3HT shows its highest current peaks for charging and discharging at 3.82 V and 3.7 V, respectively, whereas the NCA-PVdF presents its highest charging current peak around 3.9 V and lowest discharging current peak at 3.5 V. The shift in peak potential indicates that the NCA-PVdF has larger polarization compared to NCA-P3HT even at such a slow rate. b-values determined from the peak currents using Equation 1 are also shown in the figures. The higher b-values for NCA-P3HT, 0.92 during charge and 0.9 during discharge for NCA-P3HT versus 0.7 during charge and 0.8 during discharge for NCA-PVdF, are an indication that the NCA-P3HT exhibits better kinetics. This behavior is also shown by determining the variation in b-value as a function of potential (FIG. 4c) as derived from the discharge part of the CV curves in FIGS. 4a and 4b. The improved discharge kinetics of NCA-P3HT is evident from the b-values being 0.9 over nearly the entire range, whereas the NCA-PVdF shows b-values lower than 0.8 and even decreasing to unphysical values below 0.5 because of polarization at potentials higher than 3.9 V. This large polarization can be attributed to mass transport issues caused by unstable SEI/NiO parasitic reactions with the delithiated NCA surface.²¹⁻²³

The CV curves in FIGS. 4a and 4b were also used to determine the variation in peak potential position as a function of sweep rate (FIG. 4d). This variation in overpotential (dashed line in the figure) has been reported for other conducting polymer/electrode studies and is shown to be an indicator of the electrode ohmic resistance.^{46,48} During charging, the potential shifts are similar for NCA-P3HT and NCA-PVdF, suggesting that both electrodes have similar ohmic resistances in the lithiated state (before charging). However, the discharge characteristics are very different. The overpotential for delithated NCA-P3HT is significantly less than that on charge, while the values for NCA-PVdF are comparable to those obtained on charging. One source of the lower overpotential for NCA can be from the delithiated NCA becoming less resistive because the increased Ni⁴⁺/Ni³⁺ ratio leads to hole formation.⁶⁷ In addition, anion doping in the P3HT coating during discharge increases the electronic conductivity. The high overpotential of NCA-PVdF suggests that the NCA was not sufficiently delithitated and/or its surface was passivated. Indeed, similar results have been observed in studies utilizing other conducting polymer on different materials, including PEDOT-co-PEG on NMC-622 and PPy on LFP. These studies showed that the overpotential during discharge can be greatly reduced by using an oxidized (doped) polymer coating.^{46,48} In addition, the PEDOT-co-PEG coating prevented cathode surface degradation from electrolyte breakdown at high voltage, while the PPy coating provided better electrolyte penetration that reduced the potential shift of LFP redox peaks.

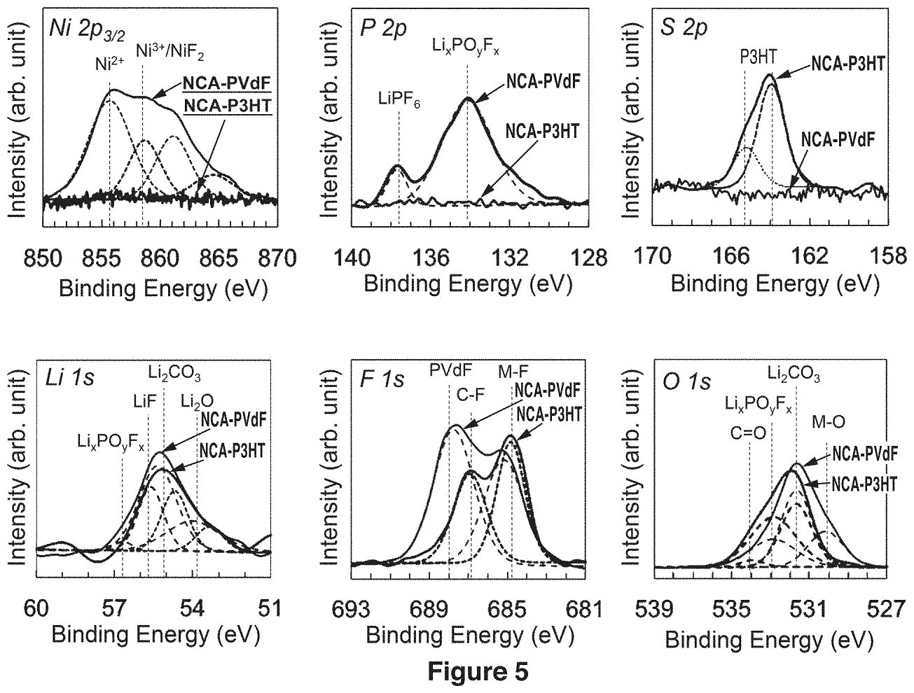

X-ray photoelectron spectroscopy (XPS) was used to compare the surface chemistry for NCA-PVdF and NCA-P3HT electrodes and provide insight regarding SEI formation on these electrodes. In analyzing the XPS results, we used previous research that has shown how Ni 2p, P 2p, S 2p, Li 1s, F 1s and O 1s spectra can be used to identify various moieties in the SEI.^{10,28} The XPS spectra shown in FIG. 5 were taken after cycling the electrodes (see FIG. 4a and b) with the NCA in the delithiated state. For the NCA-PVdF electrode, evidence of NiO, NiF₂, Li₂CO₃, Li₂O, LiF, and LiₓPO_{y}F_{z} were all found on the electrode surface. Li₂CO₃ and LiₓPO_{y}F_{z} are associated with decomposition of electrolyte.^{10,28} The dominant amount of LiₓPO_{y}F_{z} indicates that the PF₆⁻ preferentially decomposed on the delithiated NCA surface. In addition to LiₓPO_{y}F_{z}, the F 1s spectrum shows a peak at 685.2 eV for a metal fluoride. This peak can be from LiF or NiF₂ and is the result of the dissociation of LiPF₆ and/or HF attack on the NCA. The NiO disordered layer was identified from the metal oxide peak at 530.1 eV of the O 1s and further resolved with the Ni 2p spectrum showing Ni²⁺ (855.5 eV) and Ni³⁺ (858 eV).

For the NCA-P3HT electrode, Li₂CO₃, LiF, and P3HT (163.9 eV and 165.1 eV) are identified as the main components of the surface layer (FIG. 5). The absence of Ni 2p and P 2p spectra indicates that electrolyte breakdown and HF attack on the NCA surface were essentially completely suppressed. This suggests that the P3HT coating stabilizes the delithiated NCA surface by preventing direct contact between the NCA and the electrolyte, suppressing the formation of NiO and NiF₂. In addition, the F spectrum shows an extra peak at 687 eV for C—F bonds, suggesting that fluorine was involved in SEI formation with organic species.

The SEI formation mechanism for NCA-P3HT seems to be consistent with the reaction pathway proposed by Edstrom et. al.,²⁸

Li₂CO₃+ROCO₂Li+2PF5

→RF+2POF₃+3LiF+2CO_{2(g)} (2)

Li₂CO₃ and ROCO₂Li are electrolyte breakdown byproducts which react with excessive PF₅ on the P3HT surface to form LiF and RF. Due to the P3HT doping process, the PF₆⁻ ions were localized to the P3HT coating limiting exposure to the NCA particles. The PF₆⁻ decomposes into PF₅ from overoxidation of P3HT by the following reaction,⁴¹

P3HT²⁺(PF₆⁻)₂→(F⁻P3HT²⁺)(PF₆⁻)+PF5 (3)

The nucleophilic reaction on oxidized P3HT with fluorine ions generates PF₅ and, accordingly, Equation 2 leads to formation of POF₃ in the gas phase. Thus, no signal for POF₃ can be found on the P 2p and O 1s spectra for NCA-P3HT. Because the conductive P3HT coating prevents exposure of the delithiated NCA to the electrolyte, Ni cannot react with the electrolyte allowing a more stable SEI to form. Therefore, compared with PVdF, the P3HT protects the NCA particles by forming a protective and conductive SEI, which leads to significantly better charge transfer kinetics.

4. High-Rate Cyclability for NCA-P3HT Electrodes

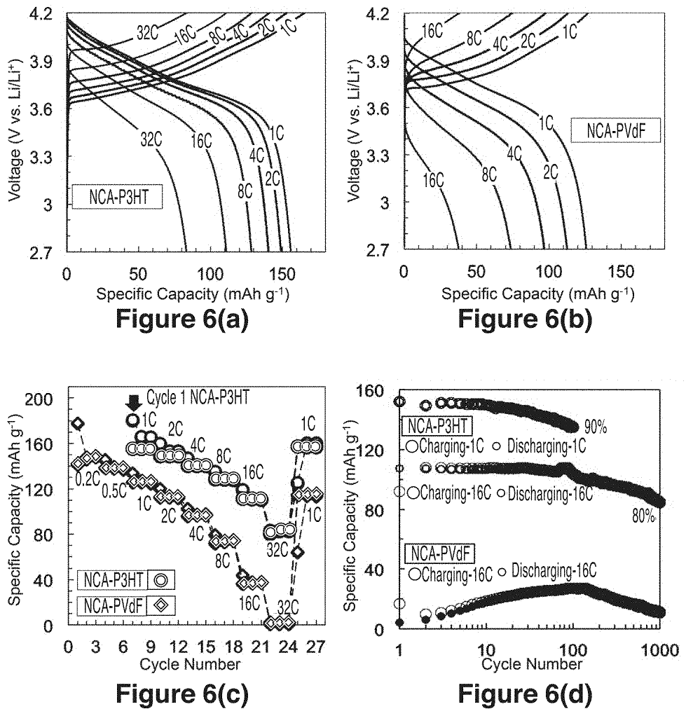

Galvanostatic charge-discharge (GCD) experiments were used to characterize the effect of charge-discharge rates on the lithium capacity of NCA-P3HT and NCA-PVdF electrodes (FIGS. 6a and 6b). At the 1C rate for both charge and discharge, NCA-P3HT exhibited a capacity of 156 mAh g-1 and was able to retain capacities of 110 mAh g-1 and 83 mAh g-1 at 16C and 32C, respectively. While the energy storage is comparable to what other groups have reported for NCA electrodes at 1C,29-33 the values at 16C and 32C are significantly greater than what is commonly reported for NCA. For the NCA-PVdF control electrode, the value at 1C is only 126 mAh g-1, which quickly drops to 38 mAh g-1 at 16C. During charging, NCA-P3HT shows less polarization than that of NCA-PVdF, especially at higher rates. The higher resistance of the NCA-PVdF electrode increases the overpotential required for lithium deintercalation/intercalation, and limits the achievable capacity over the measured voltage range.

The kinetic difference between the two electrodes is best summarized by the rate capability shown in FIG. 6c. With NCA electrodes, the capacity loss in the first charging cycle is due to the irreversible transition from the hexagonal phase to the rhombohedral phase. This diffusion-controlled process requires a relatively slow charging rate to transform the entire micron-sized NCA particle.^{12-16,66} An intriguing property of using the P3HT binder is that the time required for the phase transition in the first cycle is reduced considerably (5 hour vs. 1 hour) compared to the control electrode. The capacity for the first charge and discharge (at 1C) for NCA-P3HT is 181 mAh g⁻¹ and 156 mAh g⁻¹, respectively, leading to a coulombic efficiency of 85% (FIG. 6c). In contrast, NCA-PVdF can only be initiated at a rate of 0.16C and shows a first cycle coulombic efficiency of only 81%. Further, without CNTs, P3HT not only forms a dense coating that hinders ion transport between NCA and the electrolyte but also reduces electronic conduction because of poor doping kinetics. After cycling at 32C, the NCA-P3HT was then cycled at the 1C rate (FIG. 6c) and returned to nearly 100% (155 mAh g⁻¹) of its previous capacity at 1C. In contrast, the NCA-PVdF exhibits a 10% drop in capacity. Taken together, these results suggest that with the P3HT coating, NCA-P3HT not only shows better rate capability but keeps the SEI intact under high-rate conditions. FIG. 6d shows long-term cyclability for NCA-P3HT at 1C (0.16 A g⁻¹) and 16C (2.56 A g⁻¹). The NCA-P3HT retains 90% of its initial capacity after 100 cycles at 1C and 80% of its initial capacity after 1000 cycles at 16C. For comparison, the cyclability of NCA-PVdF at 16C is also presented in the figure, showing a capacity drop from the maximum of 27 mAh g⁻¹ to 11 mAh g⁻¹ (40%) after 1000 cycles. Clearly, the P3HT containing sample show dramatically better capacity retention in long-term cycling studies.

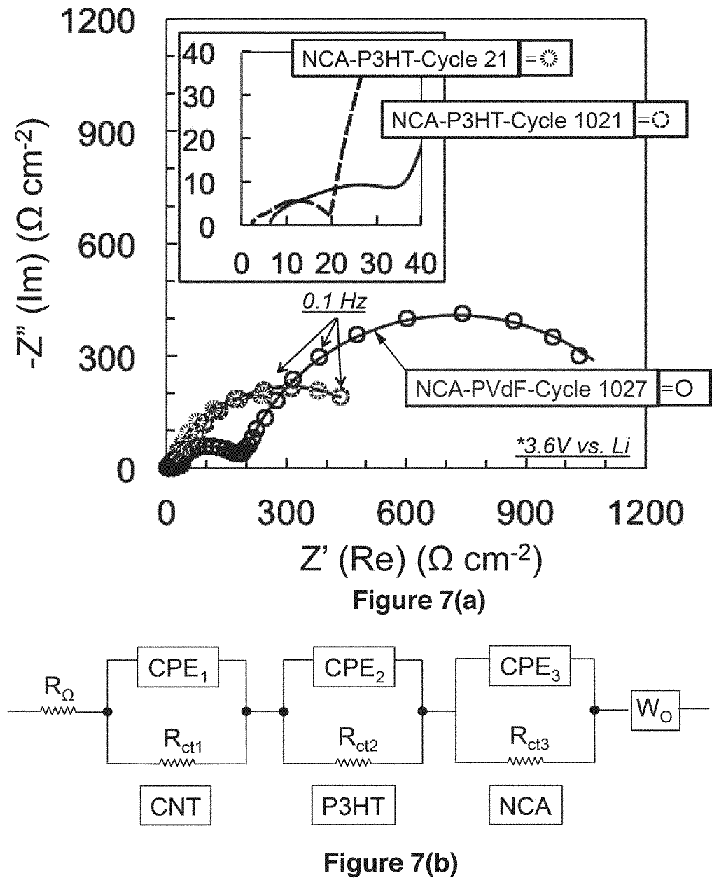

Electrochemical impedance spectroscopy (EIS) was used to model the contributions of the different components present in the NCA-P3HT and NCA-PVdF cells. FIG. 7a shows the Nyquist plots for NCA-P3HT (red) and NCA-PVdF (black) after extended cycling at 16C. The impedance spectra are fitted to a Randles equivalent circuit with three components (FIG. 7b).⁶⁴ The high-frequency and mid-frequency responses are associated with charge transport through the CNT nanostructures and P3HT coating, respectively, with their charge-transfer resistances (R_{ct1} and R_{ct2}) generally being combined to represent the SEI resistance (R_{SEI}). The semicircle at low frequency, which usually varies with state-of-charge (SOC), represents the charge-transfer resistance of bulk NCA (R_{ct3}=R_{NCA}).^{27,30,31,35,69} Compared with NCA-P3HT, the NCA-PVdF shows both higher R_{SEI} and R_{NCA}. The R_{SEI} and R_{NCA} for NCA-P3HT after 1000 cycles are 31 Ω cm⁻² and 504 Ω cm⁻², respectively, whereas the corresponding values for NCA-PVdF are some 6 times higher for the SEI (185 Ω cm⁻²) and twice as large for NCA (1073 Ω cm⁻²). The lower resistances are consistent with the formation of a more conductive SEI and reduced NCA charge-transfer resistance, leading to the improved kinetics of NCA-P3HT compared to NCA-PVdF. EIS for NCA-P3HT before high-rate cycling is also shown in FIG. 7a. The R_{SEI} of NCA-P3HT increases only slightly, from 18 Ω cm⁻² to 31 Ω cm⁻². Notably, the first semi-circle and similar resistance retained after cycling indicates that the SEI grown on the NCA surface neither blocked the CNT nanostructures nor hindered charge transport between the NCA and electrolyte. The constant values for RsEI and RNCA throughout the extended cycling are consistent with the assessment that the P3HT coating has good stability at high-rate cycling. Detailed comparisons of charge-transfer resistances are summarized in Table 1.

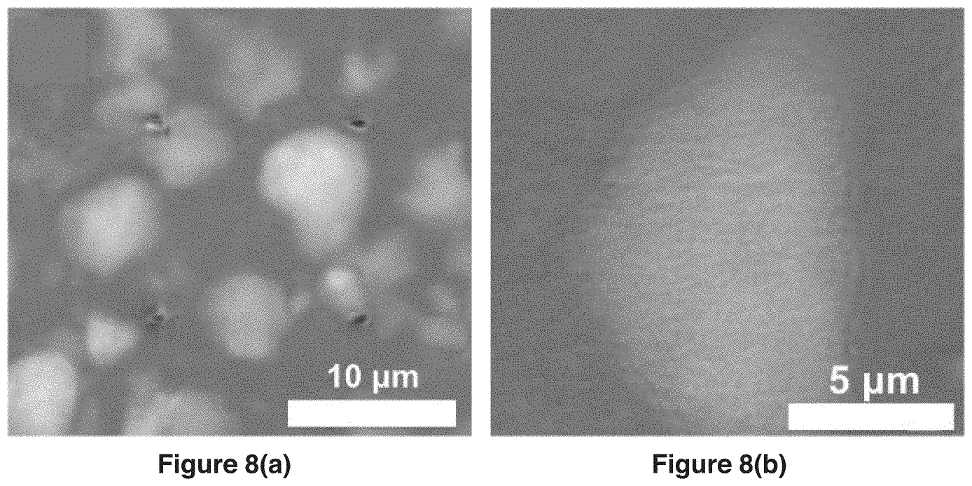

Another consideration with NCA-P3HT is whether the coating prevents fragmentation of NCA, a critical feature which influences performance, especially during cycling at high rate. To investigate NCA integrity, an electrode after 450 cycles at 16C was imaged using transmission X-ray microscopy (TXM). The electrode was retrieved from the testing cell in a glovebox, washed with DMC, and transferred to an X-ray transparent Al pouch cell for TXM imaging. FIG. 8a shows the TXM image for the cycled NCA-P3HT electrode. Fragmentation of the NCA is believed to occur due to SEI growth, NiO formation, and CO₂ evolution along the grain boundaries of NCA.^{12-14,20-23} However, the TXM image clearly shows no disintegration of primary particles on the cycled electrode. A high-magnification image for a single NCA particle in FIG. 8b further serves as strong evidence for the absence of interganular cracking. These images establish that the P3HT coating effectively suppressed SEI growth and successfully inhibited NCA fragmentation.

We end by considering the benefits of a P3HT coating, compared to other inorganic coatings. As indicated previously, the protective coating on the NCA is based on combining P3HT and CNTs. Improved rate capability and cyclability were achieved due to the higher conductivity and surface stability compared to other protective coatings. Table 2 compares different coatings used with NCA or other Ni-rich cathode materials. Oxides, phosphates, fluorides, and carbons have been successfully used as protective coatings but typically do not facilitate ion transport or provide improved electronic conduction.^{27,29-35} Among the various systems, AlPO₄ has emerged as the most effective coating at keeping NCA from harmful side reactions.³⁴ During synthesis at 700° C., the AlPO₄ reacts with Li species on the surface to form Li₃PO₄ a Li ion conductor, whereas the Al is doped into the NCA surface to suppress NiO formation. Another promising coating based on Co₃PO₄ not only improves the surface stability by forming olivine LixCoPO₄, but also the long-term cyclability by suppressing crack formation inside the NCA.²⁷ Compared to these other coating materials, NCA with a P3HT-CNT coating offers a number of advantages including particle initiation in 1 hour, high-rate charging up to 32 C, stable long-term cycling at 16C, and ease of integration. The doped P3HT coating provides enhanced electronic conductivity with good Li ion transport and, more importantly, a stable SEI on the P3HT surface. Through the doping process, P3HT traps PF₆⁻, suppressing intergranular growth of SEI that leads to disintegration of NCA particles during high-rate cycling.

C. Conclusions

The high-rate charge storage properties of the positive electrode material, LiNi_{0.8}Co_{0.15}Al_{0.05}O₂ (NCA), are improved considerably through the use of a conjugated polymer, poly (3-hexylthiophene-2,5-diyl) (P3HT), which functions as a conductive binder. The P3HT is electrochemically doped over the potential range where NCA is electrochemically active, and thus provides high electronic and ionic conductivity. When mixed with carbon nanotubes (CNTs), the resulting P3HT-CNT forms a protective coating that prevents surface degradation during charging and greatly reduces the polarization during discharging. XPS analysis confirms that the P3HT-derived SEI suppresses PF₆⁻ decomposition, limiting electrolyte breakdown on the NCA surface and preventing the NCA particles from disintegrating during long-term cycling. The energy storage properties of NCA-P3HT at 16C and 32C are significantly greater than what is commonly reported for NCA. When cycled at 16C, capacities in the range of 100 mAh g⁻¹ are obtained for the first 100 cycles. This exciting performance underscores the potential impact of using conjugated polymers as conductive binders in lithium-ion battery electrodes.

From the description herein, it will be appreciated that the present disclosure encompasses multiple embodiments which include, but are not limited to, the following:

1. A conductive binder for use in a lithium-ion battery cathode material, the conductive binder comprising a mixture of a conductive polymer and carbon nanotubes (CNT).

2. The conductive binder, cathode material, improved cathode material, or cathode of any preceding or following embodiment, wherein the conductive binder serves as a surface coating for the cathode material.

3. The conductive binder, cathode material, improved cathode material, or cathode of any preceding or following embodiment, wherein the conductive polymer comprises Poly (3-hexylthiophene-2,5-diyl) (P3HT).

4. The conductive binder, cathode material, improved cathode material, or cathode of any preceding or following embodiment, wherein the cathode material comprises LiNi_{0.8}Co_{0.15}Al_{0.05}O₂ (NCA).

5. The conductive binder, cathode material, improved cathode material, or cathode of any preceding or following embodiment, wherein oxidation of the P3HT enables high electronic and ionic conductivity to be achieved over the potential range where the NCA is electrochemically active.

6. The conductive binder, cathode material, improved cathode material, or cathode of any preceding or following embodiment, wherein the P3HT-CNT coating suppresses electrolyte breakdown, thus inhibiting growth of the solid electrolyte interphase (SEI) layer and preventing intergranular cracking in the NCA particles.

7. A conductive binder for use in a lithium-ion battery cathode material, the conductive binder comprising: a mixture of Poly (3-hexylthiophene-2,5-diyl) (P3HT) and carbon nanotubes (CNT); wherein the P3HT-CNT mixture serves as a surface coating for the cathode material; and wherein the cathode material comprises LiNi_{0.08}Co_{0.15}Al_{0.05}O₂ (NCA).

8. The conductive binder, cathode material, improved cathode material, or cathode of any preceding or following embodiment, wherein oxidation of the P3HT enables high electronic and ionic conductivity to be achieved over the potential range where the NCA is electrochemically active.

9. The conductive binder, cathode material, improved cathode material, or cathode of any preceding or following embodiment, wherein the P3HT-CNT coating suppresses electrolyte breakdown, thus inhibiting growth of the solid electrolyte interphase (SEI) layer and preventing intergranular cracking in the NCA particles.

10. An improved cathode material for a lithium-ion battery, the improvement comprising: the cathode material including a conductive binder comprising a mixture of a conductive polymer and carbon nanotubes (CNT).

11. The conductive binder, cathode material, improved cathode material, or cathode of any preceding or following embodiment, wherein the conductive binder serves as a surface coating for the cathode material.

12. The conductive binder, cathode material, improved cathode material, or cathode of any preceding or following embodiment, wherein the conductive polymer comprises Poly (3-hexylthiophene-2,5-diyl) (P3HT).

13. The conductive binder, cathode material, improved cathode material, or cathode of any preceding or following embodiment, wherein the cathode material comprises LiNi_{0.8}Co_{0.15}Al_{0.05}O₂ (NCA).

14. The conductive binder, cathode material, improved cathode material, or cathode of any preceding or following embodiment, wherein oxidation of the P3HT enables high electronic and ionic conductivity to be achieved over the potential range where the NCA is electrochemically active.

15. The conductive binder, cathode material, improved cathode material, or cathode of any preceding or following embodiment, wherein the P3HT-CNT coating suppresses electrolyte breakdown, thus inhibiting growth of the solid electrolyte interphase (SEI) layer and preventing intergranular cracking in the NCA particles.

16. An improved cathode material for a lithium-ion battery, the improvement comprising: the cathode material including a conductive binder comprising a mixture of Poly (3-hexylthiophene-2,5-diyl) (P3HT) and carbon nanotubes (CNT); wherein the P3HT-CNT mixture serves as a surface coating for the cathode material; and wherein the cathode material comprises LiNi_{0.8}Co_{0.15}Al_{0.05}O₂ (NCA).

17. The conductive binder, cathode material, improved cathode material, or cathode of any preceding or following embodiment, wherein oxidation of the P3HT enables high electronic and ionic conductivity to be achieved over the potential range where the NCA is electrochemically active.

18. The conductive binder, cathode material, improved cathode material, or cathode of any preceding or following embodiment, wherein the P3HT-CNT coating suppresses electrolyte breakdown, thus inhibiting growth of the solid electrolyte interphase (SEI) layer and preventing intergranular cracking in the NCA particles.

19. A cathode for a lithium-ion battery, the cathode comprising: a cathode material; the cathode material including a conductive binder; the conductive binder comprising a mixture of a conductive polymer and carbon nanotubes (CNT).

20. The conductive binder, cathode material, improved cathode material, or cathode of any preceding or following embodiment, wherein the conductive binder serves as a surface coating for the cathode material.

21. The conductive binder, cathode material, improved cathode material, or cathode of any preceding or following embodiment, wherein the conductive polymer comprises Poly (3-hexylthiophene-2,5-diyl) (P3HT).

22. The conductive binder, cathode material, improved cathode material, or cathode of any preceding or following embodiment, wherein the cathode material comprises LiNi_{0.8}Co_{0.15}Al_{0.05}O₂ (NCA).

23. The conductive binder, cathode material, improved cathode material, or cathode of any preceding or following embodiment, wherein oxidation of the P3HT enables high electronic and ionic conductivity to be achieved over the potential range where the NCA is electrochemically active.

24. The conductive binder, cathode material, improved cathode material, or cathode of any preceding or following embodiment, wherein the P3HT-CNT coating suppresses electrolyte breakdown, thus inhibiting growth of the solid electrolyte interphase (SEI) layer and preventing intergranular cracking in the NCA particles.

25. A cathode for a lithium-ion battery, the cathode comprising: a cathode material; the cathode material including a conductive binder; the conductive binder comprising a mixture of Poly (3-hexylthiophene-2,5-diyl) (P3HT) and carbon nanotubes (CNT); wherein the P3HT-CNT mixture serves as a surface coating for the cathode material; and wherein the cathode material comprises LiNi_{0.8}Co_{0.15}Al_{0.05}O₂ (NCA).

26. The conductive binder, cathode material, improved cathode material, or cathode of any preceding or following embodiment, wherein oxidation of the P3HT enables high electronic and ionic conductivity to be achieved over the potential range where the NCA is electrochemically active.

27. The conductive binder, cathode material, improved cathode material, or cathode of any preceding or following embodiment, wherein the P3HT-CNT coating suppresses electrolyte breakdown, thus inhibiting growth of the solid electrolyte interphase (SEI) layer and preventing intergranular cracking in the NCA particles.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1
Charge-transfer resistances in NCA-P3HT and NCA-PVdF
electrodes for the equivalent Randles circuits shown
in FIG. 7 after early stage and extended cycling.

| | NCA-P3HT | | NCA-PVdF |
|---|---|---|---|
| Charge Transfer | Early Stage | Extended Cycling | Extended Cycling |
| Resistance | (Cycle 21) | (Cycle 1021) | (Cycle 1027) |
| R_{Ω} | 2 | 6 | 4 |
| R_{ct1} | 3 | 9 | 15 |
| R_{ct2} | 15 | 22 | 170 |
| R_{ct3} | 436 | 504 | 1073 |

Unit: Ω cm⁻²

TABLE 2
Comparison on different surface coatings as artificial SEI on NCA and Ni-rich cathode materials

| | | | | Initiation | | Capacity |
|---|---|---|---|---|---|---|
| Type of | | | | C-rate/ | High Rate/ | Retention/ |
| Surface | | Coating | Cathode and | Discharge | Discharge | Cycle Number |
| Modification | Functions | Materials | Voltage Window | Capacity | Capacity | (C-rate) |
| Inorganic | a. Prevents | ZrO₂²⁹ | LiNi_{0.8}Co_{0.2}O₂ | 0.2 C/180 | 0.5 C/170 | 97%/50 |
| coating | HF attack | | 3 V-4.3 V | mAh g⁻¹ | mAh g⁻¹ | cycles |
| | b. Prevents | | | | | (0.5 C) |
| | cathode | SiO₂³⁰ | LiNi_{0.915}Co_{0.075}Al_{0.01}O₂ | 0.1 C/220 | 5 C/130 | 94%/150 |
| | dissolution | | 3 V-4.3 V | mAh g⁻¹ | mAh g⁻¹ | cycles |
| | c. Provides | | | | | (1 C) |
| | ionic | Al₂O₃³¹ | LiNi_{0.8}Co_{0.15}Al_{0.05}O₂ | 0.1 C/184 | 1 C/165 | 94%/150 |
| | conduction | | 2.8 V-4.3 V | mAh g⁻¹ | mAh g⁻¹ | cycles |
| | | | | | | (1 C) |
| | | Co₃(PO₄)₂²⁷ | LiNi_{0.8}Co_{0.16}Al_{0.04}O₂ | 0.1 C/190 | 1 C/170 | 90%/40 |
| | | | 3 V-4.3 V | mAh g⁻¹ | mAh g⁻¹ | cycles |
| | | | | | | (1 C) |
| | | AlF₃³² | LiNi_{0.8}Co_{0.1}Mn_{0.1}O₂ | 0.2 C/196 | 5 C/144 | 93%/1000 |
| | | | 3 V-4.2 V | mAh g⁻¹ | mAh g⁻¹ | cycles |
| | | | | | (0.2 C | (1 C) |
| | | | | | charging) | |
| | | LiAlF₃³³ | LiNi_{0.8}Co_{0.1}Mn_{0.1}O₂ | 0.1 C/201 | 1 C/142 | 76%/300 |
| | | | 2.75 V-4.5 V | mAh g⁻¹ | mAh g⁻¹ | cycles |
| | | | | | | (0.25 C) |
| | | AlPO₄³⁴ | LiNi_{0.8}Co_{0.2}O₂ | 0.5 C/174 | 1 C/145 | 92%/60 |
| | | | 3 V-4.3 V | mAh g⁻¹ | mAh g⁻¹ | cycles |
| | | | | | | (0.5 C) |
| | | FePO₄³⁵ | LiNi_{0.8}Co_{0.15}Al_{0.05}O₂ | 0.2 C/181 | 5 C/128 | 86%/100 |
| | | | 3 V-4.5 V | mAh g⁻¹ | mAh g⁻¹ | cycles |
| | | | | | (1 C | (1 C) |
| | | | | | charging) | |
| Carbon | Provides | CNT⁶⁹ | LiNi_{0.8}Co_{0.15}Al_{0.05}O₂ | 0.25 C/181 | 5 C/160 | 95%/60 |
| coating | electronic | | 2.8 V-4.3 V | mAh g⁻¹ | mAh g⁻¹ | cycles |
| | conduction | | | | | (0.25 C) |
| | | rGO⁷⁰ | LiNi_{0.6}Co_{0.2}Mn_{0.2}O₂ | 0.1 C/183 | 10 C/133 | 88%/100 |
| | | | 3 V-4.5 V | mAh g⁻¹ | mAh g⁻¹ | cycles (1 C) |
| | | | | | (0.1 C | (0.5 C |
| | | | | | charging) | charging) |
| Dual- | Provides | PEDOT-co- | LiNi_{0.6}Co_{0.2}Mn_{0.2}O₂ | 0.1 C/180 | 5 C/170 | 94%/100 |
| conductive | electronic/ionic | PEG⁴⁶ | 2.8 V-4.3 V | mAh g⁻¹ | mAh g⁻¹ | cycles |
| polymer | conduction | | | | (0.2 C | (0.5 C) |
| coating | | | | | charging) | |
| Anion-doped | a. Provides | P3HT | LiNi_{0.8}Co_{0.15}Al_{0.05}O₂ | 1 C/156 | 4 C/140 | 90% 100 |
| Coating | electronic/ionic | (this work) | 2.7 V-4.2 V | mAh g⁻¹ | mAh g⁻¹ | cycles (1 C) |
| | conduction | | | | 16 C/110 | 80%/1000 |
| | b. Suppresses | | | | mAh g⁻¹ | cycles |
| | SEI growth | | | | | (16 C) |

What is claimed is:

1. A conductive binder for use in a lithium-ion battery cathode material, the conductive binder comprising a mixture of a conductive polymer and carbon nanotubes (CNT).

2. The conductive binder of claim 1, wherein the conductive binder serves as a surface coating for the cathode material.

3. The conductive binder of claim 2, wherein the conductive polymer comprises Poly (3-hexylthiophene-2,5-diyl) (P3HT).

4. The conductive binder of claim 3, wherein the cathode material comprises LiNi_{0.8}Co_{0.15}Al_{0.05}O₂ (NCA).

5. The conductive binder of claim 4, wherein oxidation of the P3HT enables high electronic and ionic conductivity to be achieved over the potential range where the NCA is electrochemically active.

6. The conductive binder of claim 5, wherein the P3HT-CNT coating suppresses electrolyte breakdown, thus inhibiting growth of the solid electrolyte interphase (SEI) layer and preventing intergranular cracking in the NCA particles.

7. A conductive binder for use in a lithium-ion battery cathode material, the conductive binder comprising:
a mixture of Poly (3-hexylthiophene-2,5-diyl) (P3HT) and carbon nanotubes (CNT);
wherein the P3HT-CNT mixture serves as a surface coating for the cathode material; and
wherein the cathode material comprises LiNi_{0.8}Co_{0.15}Al_{0.05}O₂ (NCA).

8. The conductive binder of claim 7, wherein oxidation of the P3HT enables high electronic and ionic conductivity to be achieved over the potential range where the NCA is electrochemically active.

9. The conductive binder of claim 8, wherein the P3HT-CNT coating suppresses electrolyte breakdown, thus inhibiting growth of the solid electrolyte interphase (SEI) layer and preventing intergranular cracking in the NCA particles.

10. An improved cathode material for a lithium-ion battery, the improvement comprising:
the cathode material including a conductive binder comprising a mixture of a conductive polymer and carbon nanotubes (CNT).

11. The improved cathode material of claim 10, wherein the conductive binder serves as a surface coating for the cathode material.

12. The improved cathode material of claim 11, wherein the conductive polymer comprises Poly (3-hexylthiophene-2,5-diyl) (P3HT).

13. The improved cathode material of claim 12, wherein the cathode material comprises LiNi_{0.8}Co_{0.15}Al_{0.05}O₂ (NCA).

14. The improved cathode material of claim 13, wherein oxidation of the P3HT enables high electronic and ionic conductivity to be achieved over the potential range where the NCA is electrochemically active.

15. The improved cathode material of claim 14, wherein the P3HT-CNT coating suppresses electrolyte breakdown, thus inhibiting growth of the solid electrolyte interphase (SEI) layer and preventing intergranular cracking in the NCA particles.

16. An improved cathode material for a lithium-ion battery, the improvement comprising:
the cathode material including a conductive binder comprising a mixture of Poly (3-hexylthiophene-2,5-diyl) (P3HT) and carbon nanotubes (CNT);
wherein the P3HT-CNT mixture serves as a surface coating for the cathode material; and
wherein the cathode material comprises LiNio.8Coo.15Alo.o502 (NCA).

17. The improved cathode material of claim 16, wherein oxidation of the P3HT enables high electronic and ionic conductivity to be achieved over the potential range where the NCA is electrochemically active.

18. The improved cathode material of claim 17, wherein the P3HT-CNT coating suppresses electrolyte breakdown, thus inhibiting growth of the solid electrolyte interphase (SEI) layer and preventing intergranular cracking in the NCA particles.

19. A cathode for a lithium-ion battery, the cathode comprising:
a cathode material;
the cathode material including a conductive binder;
the conductive binder comprising a mixture of a conductive polymer and carbon nanotubes (CNT).

20. The cathode of claim 19, wherein the conductive binder serves as a surface coating for the cathode material.

21. The cathode of claim 20, wherein the conductive polymer comprises Poly (3-hexylthiophene-2,5-diyl) (P3HT).

22. The cathode of claim 21, wherein the cathode material comprises LiNi_{0.8}Co_{0.15}Al_{0.05}O₂ (NCA).

23. The cathode of claim 22, wherein oxidation of the P3HT enables high electronic and ionic conductivity to be achieved over the potential range where the NCA is electrochemically active.

24. The cathode of claim 23, wherein the P3HT-CNT coating suppresses electrolyte breakdown, thus inhibiting growth of the solid electrolyte interphase (SEI) layer and preventing intergranular cracking in the NCA particles.

25. A cathode for a lithium-ion battery, the cathode comprising:
a cathode material;
the cathode material including a conductive binder;
the conductive binder comprising a mixture of Poly (3-hexylthiophene-2,5-diyl) (P3HT) and carbon nanotubes (CNT);
wherein the P3HT-CNT mixture serves as a surface coating for the cathode material; and
wherein the cathode material comprises LiNi_{0.8}Co_{0.15}Al_{0.5}O₂ (NCA).

26. The cathode of claim 25, wherein oxidation of the P3HT enables high electronic and ionic conductivity to be achieved over the potential range where the NCA is electrochemically active.

27. The cathode of claim 26, wherein the P3HT-CNT coating suppresses electrolyte breakdown, thus inhibiting growth of the solid electrolyte interphase (SEI) layer and preventing intergranular cracking in the NCA particles.
